(19) United States
(12) Patent Application Publication
(10) Pub. No.: US 2026/0126297 A1
(43) Pub. Date: May 7, 2026

(54) TECHNIQUES FOR NAVIGATING NETWORK COVERAGE AND A NETWORK COVERAGE MAP OVERLAY

(71) Applicant: T-MOBILE INNOVATIONS LLC, Overland Park, KS (US)

(72) Inventors: Gregory Wade PRESTRIDGE, Olathe, KS (US); Zaheer Mohammed SIDDIQUE, Overland Park, KS (US)

(21) Appl. No.: 18/937,823

(22) Filed: Nov. 5, 2024

(51) Int. Cl. G01C 21/34; H04W 4/021; H04W 16/18; H04W 16/22

(52) U.S. Cl. CPC G01C 21/3453; H04W 4/021; H04W 16/18; H04W 16/22

(57) ABSTRACT

At a high level, the technology disclosed herein relates to navigating network coverage (e.g., cellular coverage, cellular coverage for critical use cases, etc.). For example, mobile devices, drones, electric vehicles, etc., traversing from a first location to a destination location may receive indications that one or more particular locations along a route from the first location to the destination location have low network coverage (e.g., having network coverage data that is below a threshold). Embodiments of the present technology may include generating and providing a map overlay, for a map that includes routes from the first location to the destination location, that includes locations along the route that have network coverage data below the threshold. For example, the map overlay may indicate which route has the highest network coverage ranking.

### SUMMARY

A high-level overview of various aspects of the invention are provided here to offer an overview of the disclosure and to introduce a selection of concepts that are further described below in the detailed description section. This summary is not intended to identify key features or essential features of the claimed subject matter, nor is it intended to be used as an aid in isolation to determine the scope of the claimed subject matter.

According to various aspects of the technology disclosed herein, systems, methods, media, etc., are provided for identifying various network coverage locations having particular signal strengths and qualities and for generating a map overlay that indicates network coverage locations having network coverage data that is below a threshold. For example, in an embodiment, an indication for a route from a first location to a destination location may be received from a first device, and based on receiving this indication, network coverage data may be identified for various locations on a first route from the first location to the destination location. Network coverage data may also be identified for various locations on additional routes from the first location to the destination location. For example, in some embodiments, an indication corresponding to the first route having a higher network coverage ranking than another route may be provided based on the network coverage data identified for the locations along these routes. In embodiments, a map overlay that includes the indication corresponding to the first route having the higher network coverage ranking may be provided.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 depicts an example operating environment for network coverage management, in accordance with embodiments herein;

FIG. 2 depicts an example flowchart for network coverage management, in accordance with embodiments herein; and

FIG. 3 depicts an example client device associated with the present technology, in accordance with embodiments herein.

### DETAILED DESCRIPTION

The subject matter of the present invention is being described with specificity herein to meet statutory requirements. However, the description itself is not intended to limit the scope of this patent. Rather, the inventors have contemplated that the claimed subject matter might also be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described. As such, although the terms “step” and/or “block” may be used herein to connote different elements of systems and/or methods, the terms should not be interpreted as implying any particular order and/or dependencies among or between various components and/or steps herein disclosed unless and except when the order of individual steps is explicitly described. The present disclosure will now be described more fully herein with reference to the accompanying drawings, which may not be drawn to scale and which are not to be construed as limiting. Indeed, the present invention may be embodied in many different forms and should not be construed as limited to the aspects set forth herein.

### Definitions

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms may be found in Newton's Telecom Dictionary, (e.g., 32d Edition, 2022).

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components may store data momentarily, temporarily, or permanently.

“Computer storage media” does not comprise signals per se.

For purposes of this disclosure, the word “including” or “having” has the same broad meaning as the word “comprising.” Further, the word “communicating” has the same broad meaning as the word “receiving,” or “transmitting” facilitated by software or hardware-based buses, receivers, or transmitters using communication media.

In addition, words such as “a” and “an,” unless otherwise indicated to the contrary, include the plural as well as the singular. Thus, for example, the constraint of “a feature” is satisfied where one or more features are present. Additionally, an element in the singular may refer to “one or more.”

The term “some” may refer to “one or more.”

The term “or” includes the conjunctive, the disjunctive, and both (a or b thus includes either a or b, as well as a and b).

The phrase “one or more combinations thereof” may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### Technological Overview

By way of background, cellular networks may continuously monitor the performance of base stations (e.g., cell towers) to track coverage and performance. For example, a base station may collect metrics like signal strength, call quality, handovers, data throughput, and dropped calls. Network management systems (NMS) or Operations Support Systems (OSS) may monitor these metrics in real-time and may monitor excessive dropped calls and high interference levels. Some shortcomings associated with these approaches to tracking network coverage and performance may involve how these systems mainly focus on the infrastructure side of the network and may not capture the entire user experience. By way of illustration, end-user experiences such as dropped calls and slow data speeds may go unnoticed if the problem is specific to user devices or specific to localized conditions that are invisible to these infrastructures. As another illustration, an NMS may only provide generalized coverage data from base stations without measuring the actual signal strength received by users at specific locations (e.g., indoors, in valleys, or near obstacles). In yet another illustration, an NMS may not capture hardware or software limitations associated with various devices, network configuration issues, or power constraints affecting coverage quality for individual users. As another example, these systems may not be equipped to detect coverage gaps or dead zones in areas not well-served by the current network layout.

Embodiments of the technology discussed herein provide various improvements to the challenges discussed above. For example, the technology described herein can improve network coverage detection for devices traversing through various locations (e.g., an electric or autonomous vehicle traveling from a first location to a destination location, a drone traversing from a first location to a destination location, a user device traveling from one location to another location, etc.). In embodiments, the present technology can detect coverage gaps or dead zones that previous systems have not detected, and provide various indications to these devices traversing through various locations that have the coverage gaps or dead zones. As another example, the present technology can detect locations in which the device is about to traverse that have weak network coverage based on capturing both the network coverage data from the infrastructure side of the network and the user experience side of the network. By way of illustration, in these ways, the present technology can trigger automatic downloads (e.g., of an application, media content, software updates, documents, files, navigation data, charging station location data, etc.) based on the device approaching a weak network coverage area.

In an embodiment, a system for network coverage management is provided. The system may comprise one or more processors and computer memory storing computer-usable instructions that, when executed by the one or more processors, cause the one or more processors to perform operations. The operations may comprise identifying network coverage data for locations along a first route and a second route from a first location to a destination location. The operations may also comprise determining that the first route has a higher network coverage ranking than the second route based on the network coverage data. The operations may also comprise providing an indication corresponding to the first route having the higher network coverage ranking than the second route.

In another embodiment, a method is provided for network coverage management. For example, the method may comprise receiving, from a first device, an indication for a route from the first location to the destination location. Based on receiving the indication, the method may also comprise identifying network coverage data for a first route from a first location to a destination location and a second route from the first location to the destination location. The method may also comprise determining that the second route has a lower network coverage ranking than the first route based on the network coverage data. The method may also comprise providing an indication to the first device based on the second route having the lower network coverage ranking.

In another example embodiment, one or more computer storage media having computer-executable instructions embodied thereon, that when executed by at least one processor, cause the at least one processor to perform a method. The method may comprise identifying network coverage data for a first route from a first location to a destination location and a second route from the first location to the destination location. The method may also comprise determining that the first route has a higher network coverage ranking than the second route based on the network coverage data. Based on determining that the first route has the higher network coverage ranking, the method may also comprise causing to provide a map overlay, for a map that includes the first route, the map overlay including an indication associated with the first route having the higher network coverage ranking.

### Example Operating Environments

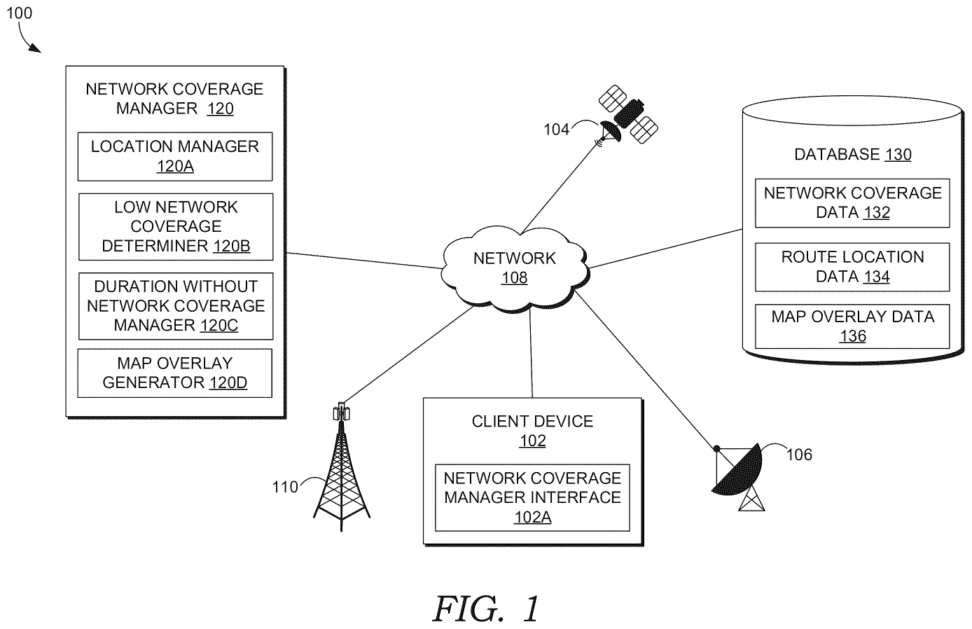

Turning now to FIG. 1, example operating environment 100 is illustrated in accordance with one or more embodiments disclosed herein. At a high level, the example operating environment 100 comprises client device 102 including network coverage manager interface 102A; non-terrestrial station 104; ground station 106; network 108; base station 110; network coverage manager 120 including location manager 120A, low network coverage determiner 120B, duration without network coverage manager 120C, and map overlay generator 120D; and database 130 including network coverage data 132, route location data 134, and map overlay data 136.

Example operating environment 100 is but one example of a suitable environment for the technology and techniques disclosed herein, and is not intended to suggest any limitation as to the scope of use or functionality of the invention. Neither should the environment 100 be interpreted as having any dependency or requirement relating to any one or combination of components illustrated. For example, other embodiments of example operating environment 100 may have additional client devices or other configurations of the database 130 (e.g., database 130 may be a distributed computing environment encompassing multiple computing devices for storing one or more of the network coverage data 132, route location data 134, and map overlay data 136).

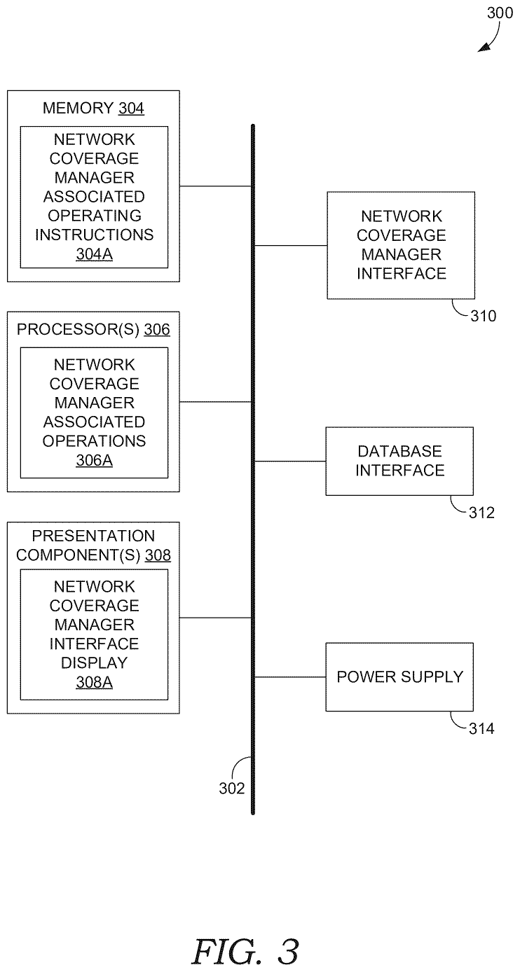

Client device 102 may be a device that has the capability of communicating (e.g., transmitting or receiving one or more signals to or from) with one or more of the non-terrestrial station 104, ground station 106, base station 110, network coverage manager 120, and database 130 over the network 108. In some embodiments, the client device 102 may be a “user device,” “computing device,” “mobile device,” “client,” “user equipment (UE),” or “wireless communication device.” In some embodiments, the client device 102 may be a server. The client device 102, in some implementations, may take on a variety of forms, such as a PC, a laptop computer, a tablet, a mobile phone, a PDA, a server, an internet-of-things device, a wearable device, a wireless local loop station, an Internet of Everything device, a machine type communication device, an evolved or enhanced machine type communication device, an autonomous vehicle device, a drone device, etc., or another type of device that is capable of communicating over the network 108. In some embodiments, the client device 102 may be example client device 300 described herein with respect to FIG. 3.

The client device 102 may be, in an embodiment, capable of providing for display, via the network coverage manager interface 102A (e.g., via presentation component(s) 308 of FIG. 3), one or more data items stored within database 130 (e.g., the network coverage data 132, route location data 134, and map overlay data 136), indications provided from the network coverage manager 120, interface displays generated by the map overlay generator 120D of the network coverage manager 120, etc., or one or more combinations thereof.

In embodiments, the network coverage manager interface 102A may be one or more presentation component(s) 308 of FIG. 3. In embodiments, the network coverage manager interface 102A may display image data, text data, extended reality data, other types of data, or one or more combinations thereof, based on one or more operations of the network coverage manager 120 (e.g., operations associated with the location manager 120A, low network coverage determiner 120B, duration without network coverage manager 120C, and map overlay generator 120D, etc.).

In embodiments, the network 108 may include one or more of a local area network (LAN), a wide area network (WAN), a mesh network, a hybrid network, a plurality of networks, another type of network, or one or more combinations thereof. In some embodiments, one or more components (e.g., client device 102, base station 110, ground station 106, non-terrestrial station 104, network coverage manager 120, etc.) illustrated within the example operating environment 100 may communicate over the network 108 via the Internet, another public or private network, etc., or one or more combinations thereof. In some embodiments, the network 108 includes 5G standalone technology (independent of 4G technology), 5G non-standalone technology, LTE network technology, another generation network technology, 802.11x, etc., or one or more combinations thereof. In embodiments, the ground station 106 operates as the backhaul communication link between the non-terrestrial station 104 and the network 108. In some embodiments, the ground station 106 may be a small cell, a gateway station, a remote ground station, a user terminal, etc. In some embodiments, the client device 102 may connect to both the base station 110 and the non-terrestrial station 104 directly.

In embodiments, the base station 110 may be a station that communicates with the client device 102, the network coverage manager 120, the non-terrestrial station 104, the ground station 106, etc. In embodiments, the base station 110 may be a macro cell, a micro cell, a picocell, femtocell, small cell, microcell, a distributed antenna system (e.g., a network of distributed antennas connected to a central source), a remote radio head, another type of access point, etc., or one or more combinations thereof. In some embodiments, the base station 110 may include an evolved node B (eNodeB) and the neighboring cell site 112 may include a next generation node B (gNodeB).

In embodiments, data stored within the database 130 may be stored based on one or more communications by the client device 102, the non-terrestrial station 104, and the base station 110. For example, the base station 110 may provide a cell identifier, carrier aggregation data, modulation (e.g., QPSK, 16QAM, 64QAM) data, handover event data, frequency band data, user density and traffic load data, neighboring cell data, quality of service data, environmental data, equipment health data, subscriber data, etc., to the network coverage manager 120, and this data may be stored in the database 130 (e.g., as network coverage data 132). As another example, this data transmitted from the base station 110 may be tagged with an associated location for storage in the database 130 (e.g., route location data 134). For instance, the data transmitted from the base station 110 may be tagged with a particular latitude and longitude value associated with a geographical location (e.g., the geographic location of a particular sector provided by the base station 110, the geographic location of the base station 110, geographic locations corresponding to a particular coverage area portion having a particular traffic load, etc.).

In addition, the client device 102, as well as other client devices, may provide Reference Signal Received Power (RSRP) values corresponding to the base station 110 or the non-terrestrial station 104, Reference Signal Received Quality (RSRQ) values corresponding to the base station 110 or the non-terrestrial station 104, Received Signal Strength Indicator (RSSI) values corresponding to the base station 110 or the non-terrestrial station 104, Signal to Interference plus Noise Ratio (SINR) values corresponding to the base station 110 or the non-terrestrial station 104, interference data corresponding to the base station 110 or the non-terrestrial station 104, throughput corresponding to the base station 110 or the non-terrestrial station 104, latency values corresponding to the base station 110 or the non-terrestrial station 104, packet loss corresponding to the base station 110 or the non-terrestrial station 104, handover data corresponding to the base station 110 or the non-terrestrial station 104, etc., or one or more combinations thereof, which may be stored in the database 130 (e.g., as network coverage data 132). In addition, the base station 110, the non-terrestrial station 104, the ground station 106, as well as other base stations, Wi-Fi devices (e.g., fixed wireless access devices), other non-terrestrial stations, etc., may provide network coverage data 132 (e.g., satellite identifier, beam width data, frequency data, etc.) for storage in the database 130. The network coverage data 132 may be tagged based on location data and timestamps associated with the network coverage data 132.

In embodiments, the network coverage manager 120 may comprise computing devices (e.g., one or more servers). In some embodiments, the network coverage manager 120 may be a single server, a distributed computing environment encompassing multiple computing devices located at the same physical geographical location or at different physical geographical locations, another type of server environment, etc. In embodiments, the network coverage manager 120 may comprise one or more processors, one or more electronics devices, one or more hardware devices, one or more electronics components, one or more logical circuits, one or more memories, one or more software codes, one or more firmware codes, etc., or one or more combinations thereof.

The network coverage manager 120 may access the database 130 to execute tasks (e.g., associated with the location manager 120A, low network coverage determiner 120B, duration without network coverage manager 120C, map overlay generator 120D, etc.). For example, a user—via the client device 102 (e.g., via the network coverage manager interface 102A)—may transmit a request to communicate with the network coverage manager 120. The network coverage manager 120 may receive, retrieve, analyze, and store the network coverage data 132, the route location data 134, the map overlay data 136, etc., at/from the database 130.

In some embodiments, the network coverage manager 120 may utilize the location manager 120A to track and manage the location information of the client device 102 and other client devices as they move throughout the network 108. For example, the location manager 120A may store network coverage data 132 and track the network coverage data 132 based on the corresponding location data for that network coverage data. As another example, the low network coverage determiner 120B can access the network coverage data 132 and the route location data 134 to determine network access rankings for routes from a first location to a destination location. Additionally, the duration without network coverage manager 120C can determine that a second route has a longer duration without network access than the first route from a first location to a destination location (e.g., based on the network coverage data 132 and the route location data 134). As another example, the duration without network coverage manager 120C can determine that the first route has a shorter duration without network access than the second route. The the duration without network coverage manager 120C can also determine a duration without network access between particular location points along each of the routes from the first location to the destination location.

In embodiments, the map overlay data 136 includes lists generated by client devices that have predetermined download files, software, applications, etc., which were user-generated. In embodiments, the map overlay data 136 includes the durations without network access between particular location points along routes determined by the low network coverage determiner 120B. In embodiments, the map overlay data 136 includes thresholds determined by the low network coverage determiner 120B for the durations without network access. In embodiments, the map overlay data 136 includes network access rankings for each of the routes for traveling from the first location to the destination location. The map overlay generator 120D can use the map overlay data 136 to generate the map overlay.

The map overlay may include locations along the first route having the network coverage data that is below a threshold. The map overlay may include locations along the second route or other routes from the first location to the destination location that have the network coverage data that is below the threshold. In an embodiment, the map overlay generator 120D can trigger an automatic download on the first device based on determining the first device is traversing the first route and based on the duration without network access being above the predetermined threshold, the automatic download corresponding to a predetermined download. In an embodiment, the map overlay generator 120D can provide an indication on the map overlay that the duration without network access between the second location and the third location is above the predetermined threshold. In some embodiments, based on determining that the first route has the higher network access ranking, the map overlay generator 120D can cause the first device to present a map overlay, for a map that includes the first route, the map overlay including an indication associated with the first route having the higher network access ranking.

### Example Flowchart

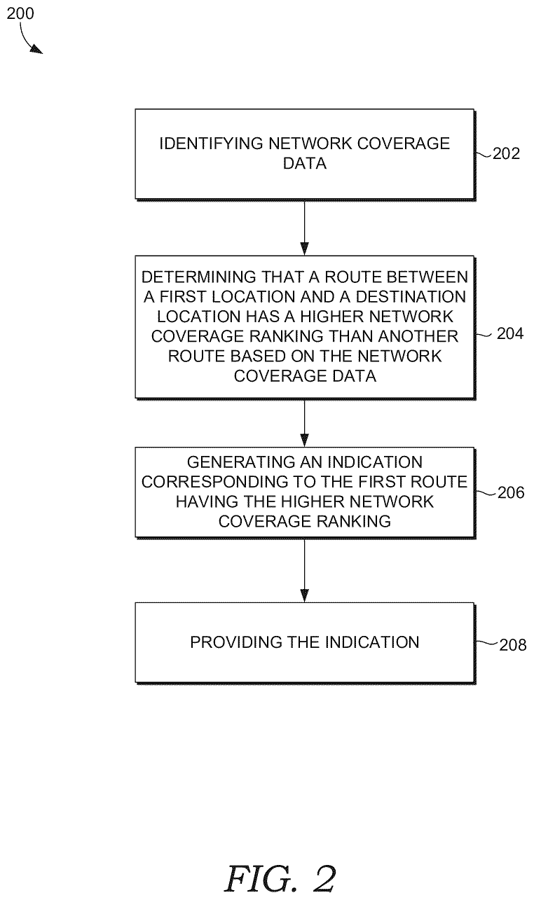

FIG. 2 includes flowchart 200, which begins at step 202 with identifying network coverage data. In some embodiments, the network coverage manager 120 of FIG. identifies the network coverage data stored within database 130. For example, in embodiments, the network coverage data may be identified for locations along one or more alternative routes from a first location to a destination location. In embodiments, the network coverage data may be identified for various locations or areas along the routes from the first location to the destination location. For instance, in embodiments, the network coverage data may be received from a first plurality of devices along a first route for each location of the locations along the first route, and network coverage data may also be received from a second plurality of devices along the second route for each location of the locations along the second route.

The network coverage data may include non-terrestrial station identifiers and locations associated with a current position in orbit, signal strength measurements provided by the plurality of devices that measured the strength of a signal between the non-terrestrial station and the ground station, latency delays in communication between the terrestrial devices and the non-terrestrial station, throughput data speeds achieved by the terrestrial devices, pack loss in transit associated with the terrestrial devices and the non-terrestrial station, non-terrestrial station beam coverage for phased array antennas that direct narrow beams to the terrestrial devices, handover between non-terrestrial stations, handover between base stations, handover between non-terrestrial and terrestrial station, base station signal strengths, base station neighboring cells and their respective signal strengths, upload/download speeds and latency in the radio access network, terrestrial device measured Signal-to-Interference-plus-Noise Ratio, terrestrial device measured Reference Signal Received Quality, terrestrial device measured Energy per Chip to Interference Ratio, terrestrial device measured Reference Signal Received Power, terrestrial device measured Received Signal Strength Indicator, interference data, etc. For example, the network coverage data may be received from a first plurality of devices and may include satellite network coverage data (e.g., signal strength measurements of non-terrestrial station signals measured by the first plurality of devices).

In some embodiments, the network coverage data may be identified based on receiving, from a first device, an indication for a route from the first location to the destination location. In embodiments, the indication may be an audio command, a virtual assistant command, an entry into a turn-by-turn application, an indication through an augmented reality navigation application, an indication through a ride-hailing and delivery navigation map, etc. In embodiments, the first device may be a mobile phone, a drone, an electronic vehicle device, an autonomous vehicle device, a server, a wearable device, etc. In some embodiments, the routes from the first location to the destination location are terrestrial routes, terrestrial routes including differing elevations and landscapes, drone flight routes or other types of non-terrestrial flight plans, a marine navigation route, a balloon route, etc.

Step 204 includes determining that the first route has a higher network coverage ranking than another route based on the network coverage data. For example, the first route may have a highest network coverage ranking among a plurality of routes identified for traversing from the first location to the destination location. In some embodiments, based on the network coverage data for locations along the first route and the network coverage data for locations along the second route, it may be determined that a second route has a longer duration without network access than the first route, that the first route has the shortest duration without network access compared to the other routes, etc. For example, the network coverage data for the locations along the first route may have a lower number of network coverage data values that are below a threshold compared to the number of network coverage data values for the other routes. As another example, the number of locations, having the network coverage data values that are below the threshold, of the first route may be lower than the number of locations, having the network coverage data values that are below the threshold, of the other routes. In yet another example, the network coverage data values that are below the threshold for the first route may be higher values than the network coverage data values for the second route.

At step 206, an indication corresponding to the first route having the higher network coverage ranking can be generated, and at step 208, the indication corresponding to the first route having the higher network coverage ranking can be provided (e.g., to an interface of the first device). In some embodiments, a map overlay that illustrates the locations along the first route from the first location to the destination location may be provided, the map overlay including the indication corresponding to the first route having the higher network coverage ranking. For example, the map overlay may provide color indicators, textual indicators, etc., or one or more combinations thereof, that indicate the first route as have the highest network coverage ranking compared to the other routes from the first location to the destination location.

In embodiments, the map overlay is a user interface feature that may be implemented for a map graphical user interface that includes directions for the first route. In some embodiments, the map in which the map overlay may be provided for may include the additional routes from the first location to the destination location (e.g., such that the map overlay is providing additional indications that the other routes have lower network access rankings). In embodiments, the additional indications that the other routes have lower network access rankings, which are provided by the map overlay, may include an indication of the particular ranking for each additional route, a duration of time without network coverage or without network access while traversing the route, indications of the areas along the routes in which network access will not be available, indications of the areas along the routes in which network signal strengths will be below a threshold, indications of travel time durations for the areas along the routes in which network signal strengths will be below a threshold, etc.

For example, the map overlay may include a duration without network access between a second location and a third location of the locations along the first route, the second location and the third location being between the first location and the destination location. For instance, the portion of the route between the second location and the third location may be a tunnel. As another example, the map overlay may include locations along the second route from the first location to the destination location and a duration without network access between a fourth location and a fifth location of the locations along the second route, the fourth location and the fifth location being between the first location and the destination location. In embodiments, the duration without network coverage between the fourth location and the fifth location may be a longer duration than the duration without network coverage between the second location and the third location.

In embodiments, it may be determined that the first device is traversing the first route (e.g., based on providing the first device the indication that the first route has the higher network access ranking). For example, it may be determined that the first device is traversing the first route based on GPS data, based on GPS coordinates and timestamps, based on base station triangulation, based on Wi-Fi and base station data, based on accelerometer data, based on gyroscope data, based on magnetometer data, etc., or one or more combinations thereof. It can also be determined that the first device is within a threshold distance of the portion of the route (e.g., between the second location and the third location along the first route) that has the network coverage data that is below the threshold. In this way, the first device can be triggered to automatically download a data file, a software update, etc., before the first device reaches the portion of the route having the low network coverage data. Stated differently, based on determining the first device is traversing the first route and based on determining the first device will approach a portion of the route having a duration without network access being above a predetermined threshold, an automatic download on the first device may be triggered, the automatic download corresponding to a predetermined download.

### Example Client Device

Referring now to FIG. 3, a diagram is depicted of an example client device suitable for use in implementations of the present disclosure. In particular, the example client device 300 is but one example of a suitable computing environment and is not intended to suggest any limitation as to the scope of use or functionality of the invention. Neither should the client device 300 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 3, example client device 300 includes bus 302 that directly or indirectly couples the following devices: memory 304, one or more processors 306, one or more presentation components 308, network coverage manager interface 310, database interface 312, and power supply 314. The memory 304 may include network coverage manager associated operating instructions 304A, which may be executed by the processor(s) 306 to perform network coverage manager associated operations 306A. The one or more presentation components 308 may include network coverage manager interface display 308A.

Although the components of FIG. 3 are shown with lines for the sake of clarity, in reality, delineating various components is not so clear, and metaphorically, the lines would more accurately be grey and fuzzy. For example, processors, such as one or more processors 306, have memory. The present disclosure hereof recognizes that such is the nature of the art, and reiterates that FIG. 3 is merely illustrative of an example client device 300 that may be used in connection with one or more implementations of the present disclosure.

In some embodiments, the client device 300 may be a “workstation,” “server,” “laptop,” “handheld device,” “computing device,” etc. For example, the client device may be, in some implementations, an autonomous vehicle, a drone, an electric vehicle device, a drone device, a wearable device, etc. In some embodiments, the client device 300 may be client device 102 of FIG. 1.

In some embodiments, bus 302 may represent what may be one or more busses (such as an address bus, data bus, or a combination thereof).

The client device 300 may include a variety of computer-readable media. Computer-readable media may be any available media that may be accessed by client device 300 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media may include RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

In embodiments, memory 304 includes computer-storage media in the form of volatile and/or nonvolatile memory. Memory 304 may be removable, non-removable, or a combination thereof. Examples of memory 304 may include solid-state memory, hard drives, optical-disc drives, etc., or one or more combinations thereof.

Example client device 300 may also include one or more processors 306 that read data from one or more entities, such as bus 302, memory 304, one or more presentation components 308, network coverage manager interface 310, database interface 312, or power supply 314. In embodiments, the network coverage manager interface 310 may be network coverage manager interface 102A of FIG. 1. In embodiments, the client device 300 may communicate with database 130 of FIG. 1 via the database interface 312, and the client device 300 may communicate with the network coverage manager 120 of FIG. 1 via the network coverage manager interface 310.

Examples of one or more processors 306 may include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, other types of processors, or one or more combinations thereof.

The processor(s) 306 may perform network coverage manager associated operations 306A. For example, the network coverage manager associated operations 306A may include transmitting an indication for a route from the first location to the destination location, transmitting network coverage data associated with a base station or satellite, transmitting coverage data associated with Wi-Fi (e.g., a service set identifier, basic service set identifier, specific frequency band, frequency channel, network mode, Received Signal Strength Indicator for the Wi-Fi strength, link quality, signal-to-noise ratio, IP address, gateway address, connection speed link rate, throughput, packet loss, latency, etc.), receiving indication of routes having a lower network coverage ranking or routes having higher network coverage rankings, receiving map overlay software updates from the network coverage manager, providing map overlays received from the network coverage manager, providing location-related indications to the network coverage manager, etc. In embodiments, the network coverage manager associated operations 306A may include causing one or more of the steps (or portions thereof) discussed above with respect to FIG. 2.

One or more presentation components 308 may present (e.g., to a person or other device) various data instances (e.g., based on operations of the network coverage manager 120 of FIG. 1). Examples of the one or more presentation components 308 may include a display device, speaker, printing component, vibrating component, etc. In some embodiments, the one or more presentation components 308 may present data received via the network coverage manager interface 310 or the database interface 312, such as the map overlay. In some embodiments, the one or more presentation components 308 may include a head-mount display.

In embodiments, the client device 300 facilitates communication with a network (e.g., via a radio). Illustrative wireless telecommunications technologies may include CDMA, GPRS, TDMA, GSM, and the like. The client device 300 might additionally or alternatively facilitate other types of wireless communications including Wi-Fi, WiMAX, LTE, or other VoIP communications. As can be appreciated, in various embodiments, the client device 300 may be configured to support multiple technologies and/or multiple radios may be utilized to support multiple technologies.

A network (e.g., a wireless telecommunications network) might include an array of devices, which are not shown so as to not obscure more relevant aspects of the invention. Components, such as a base station, a communications tower, one or more satellites, other access points (as well as other network components), or one or more combinations thereof, may provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned may be completed without departing from the scope of the claims below. Certain features and sub-combinations are of utility and may be employed without reference to other features and sub-combinations and are contemplated within the scope of the claims.

In the preceding Detailed Description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system comprising:
one or more processors; and
computer memory storing computer-usable instructions that, when executed by the one or more processors, cause the one or more processors to perform operations comprising:
identifying network coverage data for locations along a first route and a second route from a first location to a destination location;
determining that the first route has a higher network coverage ranking than the second route based on the network coverage data; and
providing an indication corresponding to the first route having the higher network coverage ranking than the second route.

2. The system according to claim 1, the operations further comprising determining that the locations along the first route have the higher network coverage ranking by:
receiving, from a first plurality of devices along the first route, a set of network coverage data for each location of the locations along the first route;
receiving, from a second plurality of devices along the second route, a set of network coverage data for each location of the locations along the second route; and
based on the set of network coverage data for each location along the first route and the set of network coverage data for each location along the second route, determining that the second route has a longer duration without network access than the first route.

3. The system according to claim 2, the operations further comprising:
receiving, from a first device, an indication for a route from the first location to the destination location; and
based on receiving the indication for the route and based on determining that the second route has the longer duration without network access, providing, to the first device, a map overlay that illustrates the locations along the first route from the first location to the destination location, the map overlay including the indication corresponding to the first route having the higher network coverage ranking.

4. The system according to claim 3, the operations further comprising providing, within the map overlay, a duration without network access between a second location and a third location of the locations along the first route, the second location and the third location being between the first location and the destination location.

5. The system according to claim 4, the operations further comprising providing, within the map overlay, the locations along the second route from the first location to the destination location and a duration without network access between a fourth location and a fifth location of the locations along the second route, the fourth location and the fifth location being between the first location and the destination location.

6. The system according to claim 5, the operations further comprising:
based on providing the duration without network access between the second location and the third location, determining that the first device is traversing the first route;
determining that the duration without network access, between the second location and the third location, is above a predetermined threshold; and
based on determining the first device is traversing the first route and based on the duration without network access being above the predetermined threshold, triggering an automatic download on the first device, the automatic download corresponding to a predetermined download.

7. The system according to claim 3, wherein the first device is a drone.

8. The system according to claim 2, wherein the set of network coverage data received from the first plurality of devices includes satellite network coverage data.

9. A method for providing network coverage data, the method comprising:
receiving, from a first device, an indication for a route from the first location to the destination location;
based on receiving the indication, identifying network coverage data for a first route from a first location to a destination location and a second route from the first location to the destination location;
determining that the second route has a lower network coverage ranking than the first route based on the network coverage data; and
providing an indication to the first device based on the second route having the lower network coverage ranking.

10. The method according to claim 9, further comprising providing, to the first device, a map overlay that includes locations along the first route having the network coverage data that is below a threshold.

11. The method according to claim 10, the map overlay further including locations along the second route having the network coverage data that is below the threshold.

12. The method according to claim 10, further comprising:
determining that the first device is traversing the first route; and
based on the network coverage data, determining that a duration without network access between a second location and a third location of the locations along the first route is above a predetermined threshold.

13. The method according to claim 12, further comprising triggering an automatic download on the first device based on determining the first device is traversing the first route and based on the duration without network access being above the predetermined threshold, the automatic download corresponding to a predetermined download.

14. The method according to claim 12, further comprising providing an indication on the map overlay that the duration without network access between the second location and the third location is above the predetermined threshold.

15. One or more computer storage media having computer-executable instructions embodied thereon, that when executed by at least one processor, cause the at least one processor to perform a method comprising:
identifying network coverage data for a first route from a first location to a destination location and a second route from the first location to the destination location;
determining that the first route has a higher network coverage ranking than the second route based on the network coverage data; and
based on determining that the first route has the higher network coverage ranking, causing to provide a map overlay, for a map that includes the first route, the map overlay including an indication associated with the first route having the higher network coverage ranking.

16. The one or more computer storage media of claim 15, wherein the map includes the second route, and wherein the operations further comprise causing the map overlay to include a location on the second route that has the network access below a threshold.

17. The one or more computer storage media of claim 16, the operations further comprising causing the map overlay to include a duration without network access for the location on the second route that has the network access below the threshold.

18. The one or more computer storage media of claim 15, the operations further comprising causing the map overlay to include a location on the first route that has the network access below a threshold.

19. The one or more computer storage media of claim 18, the operations further comprising causing the map overlay to include a duration without network access for the location on the first route that has the network access below the threshold.

20. The one or more computer storage media of claim 19, the operations further comprising:
determining that a first device is traversing the first route;
determining that the first device is within a threshold distance from the location on the first route that has the network access below the threshold; and
causing the first device to automatically download data based on the first device being within the threshold distance.
